(19) United States
(12) Patent Application Publication
(10) Pub. No.: US 2003/0036885 A1
(43) Pub. Date: Feb. 20, 2003

(54) Consumer product status monitoring

(76) Inventors: Henri Jacques Suermondt, Sunnyvale, CA (US); Kave Eshghi, Los Altos, CA (US); Evan Kirshenbaum, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 09/931,479

(22) Filed: Aug. 16, 2001

(51) Int. Cl. G06F 15/00; G06F 17/40

(52) U.S. Cl. 702/187

(57) ABSTRACT

Data collection and display representative of at least one characteristic relevant to a product contained in a sealed package, via monitoring at least one characteristic associated with a state condition of said product and displaying a history of said characteristic. The state condition is related to probability of degradation of the product. The monitoring further includes the possibility of analyzing data associated with said characteristic and, based on said analyzing, determining a current state condition of said product which is also displayed. When said current state condition is violative of a predetermined rule, freezing said display with said signal representative of said current state condition or dynamically altering an expiration date.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO AN APPENDIX

Not Applicable.

### BACKGROUND OF THE INVENTION

1. Field of the Invention

The present invention relates generally to packaging and, more particularly, to a sensing and displaying pertinent history information associated with a consumer product.

2. Description of Related Art

Numerous consumer products are sensitive to time, environment, and handling. As examples, wine is best kept a constant moderate temperature, while meat and some dairy products need constant refrigeration; fruits and vegetables are subject to damage by rough handling (“G-loads”); photographic film can be affected by radiation and temperature and humidity changes; and the like.

Generally, products having such sensitivities are sometimes labeled regarding a specific factor relevant to a decision to purchase the individual item. For example, some products are date stamped so that the consumer can determine freshness. However, most manufacturers or suppliers are very conservative in their estimates, assuming some average degree of mishandling and perishability into these type of product warning calculations. Thus, this labeling is an error-prone test for current product condition and also can lead to waste when a safe product is summarily discarded as expired. Some products bear handling instructions (which the consumer can only presume that the shipper has followed).

For the main part, consumers now use a combination of imprecise proxy measures to draw conclusions about a product. They can inspect the packaging for damage; they can try to detect signs of product decay (e.g., odor); they can notice current condition (e.g., refrigerated); they can take into account the reputation of the retailer, shipper, and suppliers. However, none of these measures give any accurate information about the actual previous handling of the product since it has left its point of origin.

Some products are re-inspectable and re-certifiable as to current condition; e.g., fire extinguishers which have a charge (pressure) gauge; some batteries are packaged with a “tester” to determine if they are still charged. These mechanisms provides a slightly better indicator for the consumer as to current condition. However, there are few, if any, labels providing dynamically generated historical data which would be of interest to the consumer; e.g., “what is the travel history of this wine?” In other words, in these current condition mechanisms there is no record visible to the consumer that the product has been handled appropriately in transit from the producer to the present time.

There is a need for a system including a sensing apparatus with display capability which provides the history of at least one measurable factor associated with a specific product that affects the characteristics of that product. The apparatus should have a data display which assures the consumer that a packaged product has been handled appropriately according to certain measurable parameters over its life since the package was sealed. The apparatus should help enhance consumer satisfaction and safety. The apparatus should give consumers accurate and detailed information about the previous handling of the product, about the current status of the product, and about the expected expiration date, if any. The apparatus may even provide a conclusion about the status of the product; e.g., current safety for consumption, use, or the like.

### BRIEF SUMMARY OF THE INVENTION

In its basic aspect, the present invention provides a system for providing a history of at least one characteristic relevant to a sealed product, including: sensing mechanisms for recording historical data representative of said characteristic; and associated with said sensing means, at least one display mechanism for exhibiting said historical data.

In another aspect, the present invention provides a method for providing data representative of at least one characteristic relevant to a product contained in a sealed package, the method including: monitoring at least one characteristic associated with a state condition of said product; and displaying a history of said characteristic.

In still another aspect, the present invention provides a method of packaging a product, the method including: affixing a data sensor to a sealable containment wherein said sensor maintains a transmittable data history of at least one characteristic associated with status of said product; and sealing said product in said containment.

In yet another aspect, the present invention provides a product package including: a sealable containment for a consumable product; affixed to said containment, a product characteristic sensor; and associated with said sensor, a memory device for receiving and transmitting data representative of a history of said product characteristic.

The present invention also provides a perishable product monitoring system including: a resealable containment for holding said product; a product data collection device associated with parameters related to perishability wherein said data collection device is configured for attachment to said resealable containment; and associated with said data collection device, a display for exhibiting at least one signal associated said perishability.

Yet another aspect of the present invention is a method for storing a perishable product, the method including: releasably sealing the product in a closed containment; monitoring parameters associated with perishability of said product; displaying in real time at least one characteristic of said product related to said perishability; and removing said perishable product from said closed containment based on said at least one characteristic.

The foregoing summary is not intended to be an inclusive list of all the aspects, objects, advantages and features of the present invention nor should any limitation on the scope of the invention be implied therefrom. This Summary is provided in accordance with the mandate of 37 C.F.R. 1.73 and M.P.E.P. 608.01 (d) merely to apprise the public, and more especially those interested in the particular art to which the invention relates, of the nature of the invention in order to be of assistance in aiding ready understanding of the patent in future searches. Other objects, features and advantages of the present invention will become apparent upon consideration of the following explanation and the accompanying drawings, in which like reference designations represent like features throughout the drawings.

### BRIEF DESCRIPTION OF THE DRAWINGS

FIG. 1 is a schematic, generic illustration of the present invention associated with a consumer product.

FIG. 1A is a schematic block diagram for the basic apparatus of the present invention as shown in FIG. 1.

FIG. 2 is an alternative embodiment of the present invention.

FIG. 3 is a flow chart for operation of an exemplary embodiment in accordance with the present invention as shown in FIG. 1.

FIG. 4 is a schematic depiction of a uniform system for product monitoring implemented in accordance with the present invention.

The drawings referred to in this specification should be understood as not being drawn to scale except if specifically annotated.

### DETAILED DESCRIPTION OF THE INVENTION

Reference is made now in detail to a specific embodiment of the present invention, which illustrates the best mode presently contemplated for practicing the invention. Alternative embodiments are also briefly described as applicable.

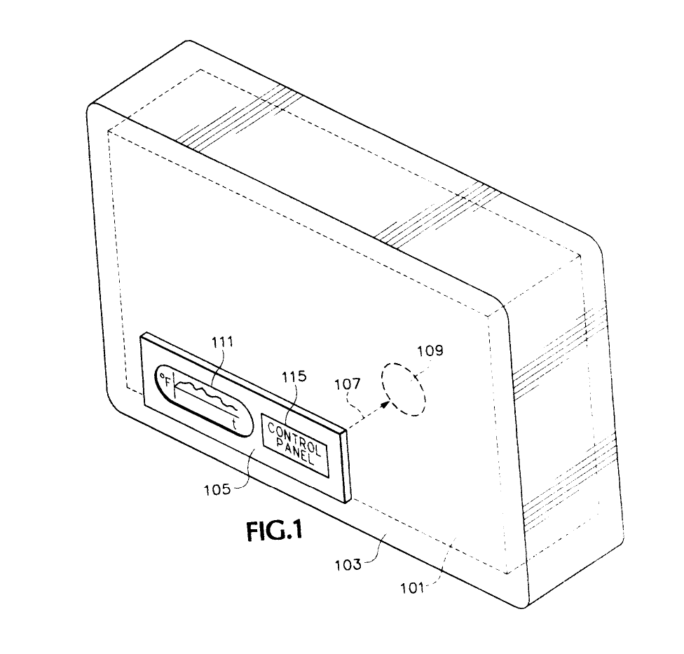

Turning to FIG. 1, a generic product 101, which has at least one characteristic that changes over time, is illustrated as being sealed in a shipping package 103. For the purpose of explaining the invention, assume that the product is an edible product that spoils if the temperature is not maintained within a specified range and that the product life (expiration) in any case is approximately a month; e.g., an expensive, fresh packed (versus canned), caviar. A monitor 105 is affixed, preferably in a tamper proof manner, to the package 103. The monitor 105 apparatus includes a sensor probe 107 for measuring temperature affixed, preferably, (represented by connection 109) to the edible product 101 itself.

As shown in FIG. 1A, in addition to the probe 107, the monitor 105 apparatus also includes electronic circuitry 106 for processing data from the probe, e.g., an application specific integrated circuit (ASIC), a memory 113, and a display 111. The monitor includes a power supply such as a battery, solar cell, or the like, 110 appropriately connected as needed for any specific electronics package implementation.

In the simplest implementation, the display 111 can be a “GOOD/BAD” indicator. That is, in the present example, based on the historical record in memory, if during the thirty day product life a temperature excursion outside the specified range for a significant predetermined period of time occurs, the indicator display 111 flips from “GOOD” to “BAD” (“SPOILED,” “DISCARD,” or the like warning against consuming the edible(s) 101 contained in the package 103). In the preferred embodiment, however, it is assumed that the consumer is interested in a more complete history of the product in order to make an informed decision about a purchase. Therefore, the display 111 is configured to show a history of the characteristic over time; in this case, shown in FIG. 1 as a plot of temperature (“OF”) versus time (“t”) where time runs from the origin when the package 103 was sealed, assumably under the supplier's closely maintained packaging conditions, to the present time.

For more complex data monitoring, processing, and display, controls 115 may be included as part of the monitor 105 apparatus; e.g., for scrolling data on a dynamic display 111 such as a liquid crystal display (LCD) screen, displaying different sets of recorded data, and the like.

To summarize, a consumer product 101 is fitted with a monitor 105 that measures one or more parameters that are relevant to the appropriate handling of the product. These measurements may be of the product itself or may be of the surrounding environment, e.g., ambient temperature, pressure, and humidity. The history of these measurements is recorded by the monitor 105 apparatus; the record may be via a direct display device or may be in a data form such that dynamic periodic updating of a separate display may be made with all measurements, a set of recent measurements, or important measurements (high, low, median or average).

The monitor 105 apparatus may be provided with the ability of deriving a conclusion about the likely handling or status of the consumer product (“SAFE” or “UNSAFE”) based on the historical data for display to the consumer. A most practical implementation for analysis and conclusion is to provide a dynamically alterable expiration date (to extend the foregoing example, if the caviar was refrigerated at the low end of the predetermined proper storage temperature range for the entire thirty days, the expiration date might be extended for a week or until the package temperature raised out of the range).

The sensor 107 measurements can be continuous or according to a periodic sampling based upon the nature of the characteristic being monitored. The measurement history can be displayed as a set of time-stamped alphanumeric figures or symbols or in graphical form or as a discrete set of possible conclusions about the handling history.

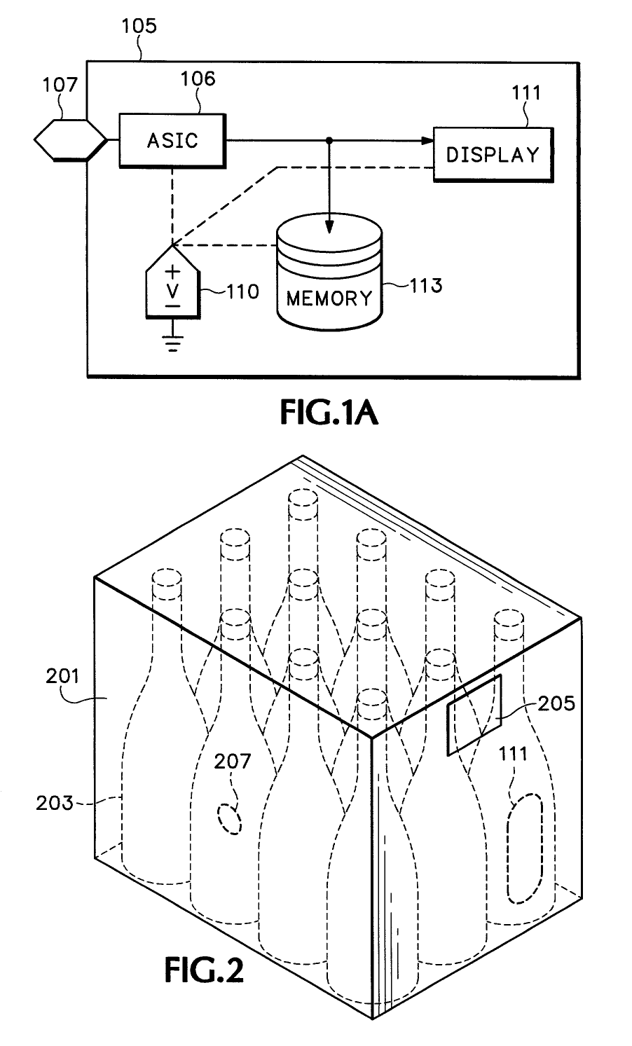

FIG. 2 illustrates an embodiment where the handling and environmental history conditions of a shipping container having a plurality of separately sealed product units is involved; e.g., a case 201 (of the re-usable wooden type known in the art) of bottled wine 203. In this embodiment, the actual measurement of a critical parameter, e.g., ambient temperature, is performed by a sensor 205 that is external to the consumer products, viz., the wine in the bottles, itself. Ambient temperature can optionally be shown on a monitor display (see e.g., FIGS. 1, 1A, element 111) on the case 201. Note however that for such implementations the data should also be transmitted (wired or wireless) to each salable unit 203, viz., transmitted to individual displays 111 on each bottle in the event the case is broken up at retailer distribution. Note also that the reverse configuration of monitor apparatus also can be implemented, providing a sensor that is in intimate contact with the product (e.g., a transmitting, pH detector 207 molded into the glass each bottle 203) transmitting data to a single display (e.g., a strip chart for each bottle on one screen or printout).

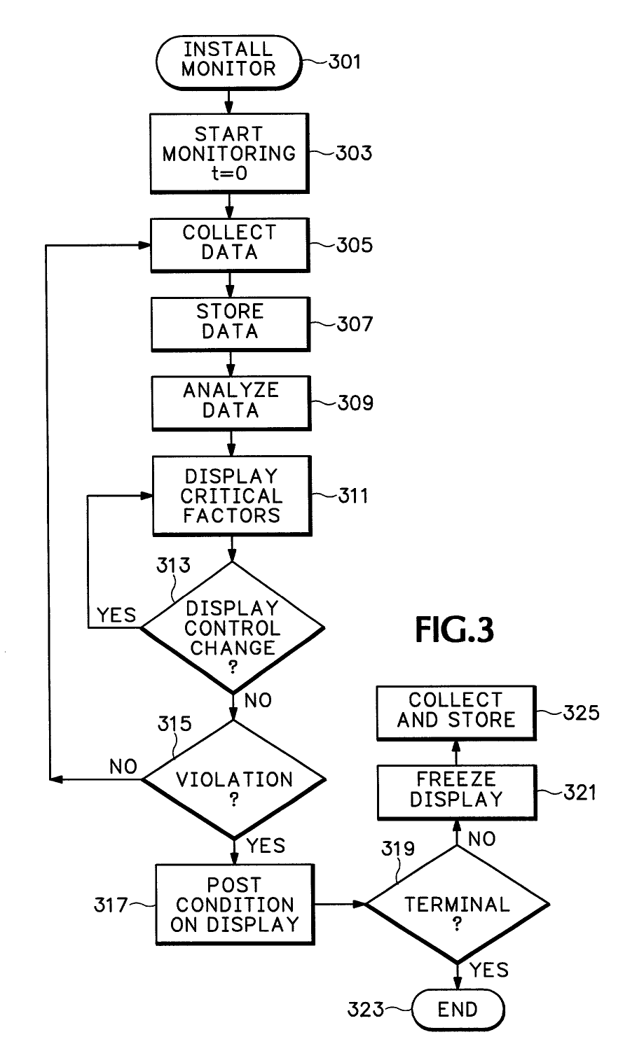

FIG. 3 is a flowchart of an exemplary operation of the present invention wherein a unified system of data monitoring, storage and display is provided. The manufacturer or supplier installs the data collecting monitor at the time the product is seal in its package. The monitoring of historical data for the parameter(s) of interest that are related to the specific product begins immediately, step 303. The data is collected and stored on either a continuous or relevant sampling period basis, step 307. In the preferred embodiment, real time analysis of the data is provided, e.g., via ASIC 106), step 309. The data representative of critical factors associated with a decision regarding purchase or use of the product is displayed, step 311. In an embodiment where there are a plurality of parameters of interest to the consumer, display control is provided, step 313, allowing the user to change the current display, step 313, YES-path. The data can be associated with predetermined rules associated with the specific product. As long as a rule is not violated, data monitoring, storage, and storage continues, step 315, NO-path. If a rule is violated, step 315, YES-path, a warning or other symbolical representation of the violation is displayed, step 317. If the violation is terminal to use of the product, step 319, YES-path, the process ends, step 323, leaving the posted warning (step 317). If the violation is not terminal, step 319, NO-path, the display is nonetheless frozen with the warning of the violation, step 321, and the data collection and storage continues, step 325, for future data access and analysis.

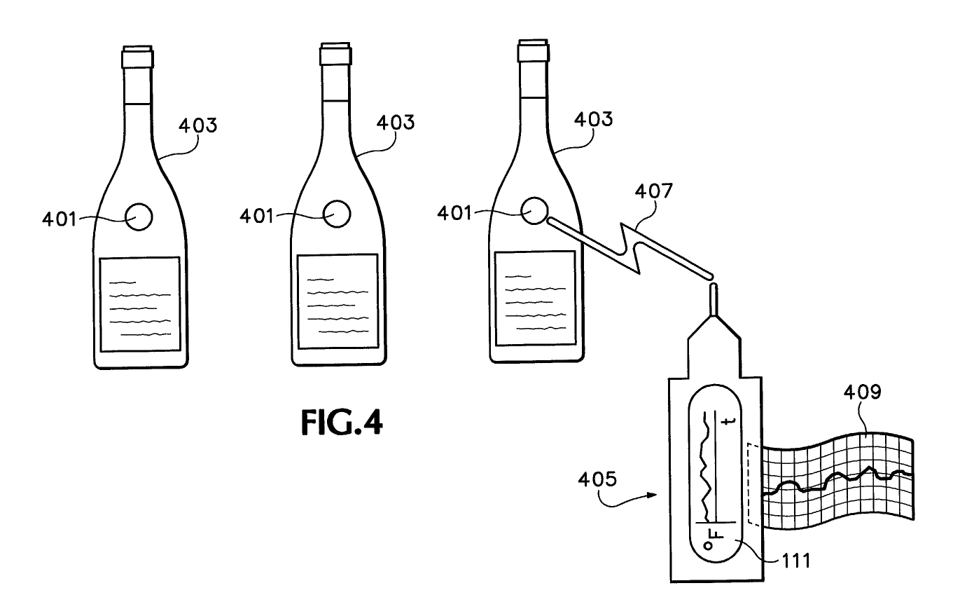

FIG. 4 demonstrates a uniform system by which critical product data tracking and display can be implemented. Product characteristic sensor-transmitters 401 are attachable to individual products 403 (e.g., bottles of wine) 20 wherein a standard industry protocol is adopted for the data recording and subsequent transmission format. Then, a separate, portable, receiver-display 405 is implemented wherein bringing the receiver-display into contact with a sensor-transmitter output port (wired transmission) or into proximity to a sensor-transmitter (wireless; illustrated by “lightening bolt” symbol 407) results in a display 111 or printout 409 (e.g., from an incorporated ink-jet plotter; not shown), or both, of the historical data. Known manner, programmable controls (e.g., ASIC, or microprocessor, based with a LCD touch screen) can be provided (not shown, but see FIG. 1, element 105) as part the receiver-display 405.

Note that while an individual sensing element (e.g. 107, 109 FIGS. 1 and 1A or 401 FIG. 4) might be mass produced relatively inexpensively, e.g., a wine case monitor 105 or receiver-display 405 would be a relatively expensive apparatus. Therefore, a programmable reset function should be implemented in the monitor 105 or receiver-display 405. At the same time, to ensure accuracy in the data, the sensing element and its associated memory should be essentially tamperproof.

In addition to temperature, characteristics of consumer interest which can be measured in accordance with the state of the art include:

humidity;

pressure;

oxygen levels, carbon dioxide levels, sulfite levels, or other chemical affective levels; pH;

shock and acceleration/deceleration levels;

exposure to pathogens;

light exposure, including ultraviolet and infrared;

radiation exposure;

orientation;

volume;

color changes;

fluid level changes.

This list is not considered to be all inclusive as it will be recognized by those skilled in the art that there are a vast variety of product dependent characteristics, changes in those characteristics, and level of interest dependent upon the specific product with which the present invention is associated and can even be tailored to a specific consumer's level of interest(s); no limitation on the scope of the invention is intended nor should any be implied therefrom.

Note that provision can be made for a computerized, known manner, upload of measurement data to external mass data storage (other than on-board memory 113, FIG. 1A); e.g., sensors mounted on wine casks can transmit to a remote central processing unit.

In an alternative embodiment, the data collection (e.g., step 305, FIG. 3) device(s) (e.g. 105-109, FIG. 1) are integrated with a resealable container (e.g., element 103 as a plastic tub with a removable lid, a zipper-type plastic bag, or the like as would be known in the art), either with a display (e.g., 111) or attachable in a known manner (e.g., via cable and plug-jack) to a permanent display associated with a refrigerator (or other environmental control chamber, e.g., a humidor). The resealable container may be either disposable or, if the data collection device is provided with a reset function, reusable. The consumable product is placed in the container and the data collection device initiated (e.g., step 303). For example, leftover food is put in the container, sealed, data collection initiated via the controls 115 appropriately to conditions of interest (basically “freshness” factors). The display then provides real time data, estimate of remaining life, or simply a warning indicator (e.g., “STALE/DISCARD”), when certain changes are monitored. Note again, that the parameters for monitoring might be fixed in accordance with the type of box such as in FIG. 2; e.g., a fruit shipping box may have a fixed program for monitoring parameters associated with the particular fruit type.

Based on a specific implementation the data collection device (with or without integrated display) can be provided with a known manner mechanism for attaching the device to the product container.

The foregoing description of the preferred embodiment of the present invention has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . ” and no process step herein is to be construed under those provisions unless the step or steps are expressly recited using the phrase “comprising the step(s) of . . . ”

What is claimed is:

1. A system for providing a history of at least one characteristic relevant to a sealed product, comprising:
sensing means for recording historical data representative of said characteristic; and
associated with said sensing means, display means for exhibiting said historical data.

2. The system as set forth in claim 1, said sensing means further comprising:
a device for tracking a characteristic of said product.

3. The system as set forth in claim 1, said sensing means further comprising:
a device for tracking at least one ambient atmospheric condition associated with said product.

4. The system as set forth in claim 1, said sensing means further comprising:
a device for periodically taking a sample of said characteristic and recording data representative of said sample.

5. The system as set forth in claim 1, said sensing means further comprising:
a device for continuously monitoring said characteristic and recording data representative thereof.

6. The system as set forth in claim 1 comprising:
an individual said display means is affixed to said product.

7. The system as set forth in claim 1, said display means further comprising:
a display of a history of said characteristic since said product was sealed.

8. The system as set forth in claim 7 wherein said history is based on periodic sampling of said characteristic.

9. The system as set forth in claim 7 wherein said history is based on continuous sampling of said characteristic.

10. The system as set forth in claim 1 wherein said data is recorded by said sensing means and displayed by said display means in accordance with a uniform data tracking and transmission protocol.

11. The system as set forth in claim 1 wherein said display means is resettable.

12. The system as set forth in claim 1 wherein said sensing means is tamperproof.

13. The system as set forth in claim 1 wherein said historical data is representative of an individual characteristic of a single said sealed product.

14. The system as set forth in claim 1 wherein said historical data is representative of a said characteristic associated with a plurality of associations of said product.

15. The system as set forth in claim 1 further comprising:
means for analyzing historical data recorded by said sensing means and for providing data indicative of a conclusion regarding condition of said product based upon said analyzing.

16. The system as set forth in claim 15 wherein said display means displays said conclusion regarding condition of said product.

17. The system as set forth in claim 1 wherein said system is removably attachable to said product and said sensing means and said display means are resettable.

18. The system as set forth in claim 1 wherein said sensing means and said display means are discrete units having a separate means for interconnection.

19. The system as set forth in claim 1 incorporated into a product package.

20. A method for providing data representative of at least one characteristic relevant to a product contained in a sealed package, the method comprising:
monitoring at least one characteristic associated with a state condition of said product; and
displaying a history of said characteristic.

21. The method as set forth in claim 20, said monitoring further comprising:
analyzing data associated with said characteristic and, based on said analyzing, determining a current state condition of said product.

22. The method as set forth in claim 21 further comprising:
displaying a signal representative of said current state condition.

23. The method as set forth in claim 22 further comprising:
when said current state condition is violative of a predetermined rule, freezing said display with said signal representative of said current state condition.

24. The method as set forth in claim 21 where in said current state condition is a dynamically alterable expiration date.

25. The method as set forth in claim 20 wherein said state condition is related to probability of degradation of the product.

26. A method of packaging a product, the method comprising:
affixing a data sensor to a sealable containment wherein said sensor maintains a transmittable data history of at least one characteristic associated with status of said product; and
sealing said product in said containment.

27. A product package comprising:
a sealable containment for a consumable product;
affixed to said containment, a product characteristic sensor; and
associated with said sensor, a memory device for receiving and transmitting data representative of a history of said product characteristic.

28. A perishable product monitoring system comprising:
a resealable containment for holding said product;
a product data collection device associated with parameters related to perishability wherein said data collection device is configured for attachment to said resealable containment; and
associated with said data collection device, a display for exhibiting at least one signal associated said perishability.

29. The system as set forth in claim 28 wherein said display is integrated with an environmental control chamber and said data collection device is releasably connected to said display.

30. The system as set forth in claim 28 wherein said data collection device is resettable.

31. A method for storing a perishable product, the method comprising:
releasably sealing the product in a closed containment;
monitoring parameters associated with perishability of said product;
displaying in real time at least one characteristic of said product related to said perishability; and
removing said perishable product from said closed containment based on said at least one characteristic.
